(19) United States
(12) Patent Application Publication
(10) Pub. No.: US 2026/0037793 A1
(43) Pub. Date: Feb. 5, 2026

(54) APPARATUS AND METHODS FOR APPROXIMATE NEURAL NETWORK INFERENCE

(71) Applicant: SpinEdge Ltd, Tel-Aviv (IL)

(72) Inventors: Konstantin Anatolievich ZVEZDIN, Turin (IT); Dmitry Roaldovich LESHCHINER, South Yarmouth, MA (US); Sergey Yurievich SEDYKH, Moscow (RU)

(73) Assignee: SpinEdge Ltd, Tel-Aviv (IL)

(21) Appl. No.: 19/161,346

(22) PCT Filed: Mar. 29, 2023
(86) PCT No.: PCT/IL2023/050328

§ 371 Date: Sep. 2, 2025

Related U.S. Application Data
(60) Provisional application No. 63/324,922, filed on Mar. 29, 2022.

(51) Int. Cl. G06N 3/065

(52) U.S. Cl. CPC G06N 3/065

(57) ABSTRACT

Apparatus including a plurality of non-volatile memory cells of variable resistance organized to perform an instant analog approximation for a reliable neural network inference. by a current distribution governed by conductivity of the circuit elements. of an output for a neural network layer of a size not limited, within the common neural network inference practice, by the ratio of resistance of memory cells to the resistance of connection lines. The apparatus includes a plurality of connection lines and may further include a plurality of control celis/devices to organize an ensemble of non-volatile memory cells of variable resistance to perform the reliable instant analog approximation of the output for the neural network layer of the size not practically limited by the ratio of resistance of memory cells to the resistance of connection lines.

### FIELD OF INVENTION

Presented is apparatus and methods for a fast and efficient approximate neural network inference.

### BACKGROUND

Currently, the practical tasks of using (calculating the inference results of) neural networks with a practically justified speed require large computational hardware resources, being costly and also quite energy inefficient. Currently such tasks may only be solved on powerful servers, while there is a market request to perform these calculations on edge devices of the Internet of Things networks. Edge devices do not have sufficient energy resources to support calculations in server mode; it is impossible to use current digital processors there. A low power alternative could be offered by low-powered analog approximation devices to perform neural network inference.

Several publications relate to instant analog methods of computation for neural network approximation. These include U.S. Pat. No. 8,275,727B (“Hardware analog-digital neural networks”); U.S. Pat. No. 10,339,202B2 (“Resistive memory arrays for performing multiply-accumulate operations”); U.S. Pat. No. 10,534,840B1 (“Multiplication using non-volatile memory cells”, SanDisk); U.S. Pat. No. 10,643,705B2 (“Configurable precision neural network with differential binary non-volatile memory cell structure”, SanDisk); U.S. Pat. No. 9,152,827B2 (“Apparatus for performing matrix vector multiplication approximation using crossbar arrays of resistive memory devices”, US Air Force); and U.S. Pat. No. 10,740,671B2 (“Convolutional neural networks using resistive processing unit array”, IBM). However, the practically useful analog approximation device requires the reliability of approximation, and an ability to process the sufficiently practically large networks. Few companies exist that offer or are going to offer analog technologies. Among them are Mythic, Syntiant, Ambient Scientific and Analog Inference. Analog Inference have not released a product yet, the character of the future product is also unknown. Analog Inference and Ambient Scientific are not going to offer a product that uses non-volatile memory, which severely limits the product's use in edge applications. Syntiant and Ambient Scientific offer products for small and medium size neural networks only (50 neurons for Ambient Scientific, 512 neurons for Syntiant). Both Mythic and Syntiant offer solutions based on Flash memory. Flash memory allows larger network sizes and it is non-volatile, but it does not allow sufficiently low energy consumption. Energy consumption per operation, measured in mW/TOPS, is 120 for Mythic, 50 for Syntiant, but it could be about 5 mW/TOPS or less for the Magnetic Tunnel Junction (MTJ) based non-volatile memory. Most examples of the present invention are based on MTJ cells and Magnetic Tunnel Barrier technology.

It turns out that in the conventional realization of the analog approximation, the low ratio of resistance of memory cells to resistance of connection lines poses severe limitations on the size of the network layers, which severely limits the network's prediction power. The present invention resolves the issue of such limitations on the size of the network layers by providing analog approximation solutions where the size of the network layers is not practically limited by ratio of resistance of memory cells to resistance of connection lines.

### SUMMARY

The present invention allows solving the technical problem of construction of, and increasing the energy efficiency of, analog accelerator for artificial intelligence (neural networks) where the size of the network layers is not practically limited by ratio of resistance of memory cells to resistance of connection lines.

In the prior art group of solutions, the memory crossbar-based analog acceleration is based on the electric properties of resistive circuits. A grid of resistive memory cells is used to perform the most expensive and frequent operations in neural networks inference-MAC (multiply-accumulate) directly in the analogue domain. A grid of resistive memory cells produces output currents, representing the results of MAC operations in accordance to Ohm's and Kirchhoff's laws for the multiplication of cell's conductivity, representing neural network weights, by voltage levels, representing the neural network's layer inputs, and to Kirchhoff's law for the summation of the currents. The instant actuation character of the solution is ensured by the immediate propagation of the current. In the conventional realization of the scheme the low ratio of resistance of memory cells to resistance of connection lines poses severe limitations on the size of the network layers, which severely limits the network's prediction power. The present solutions are offered to resolve the issue of such limitations on the size of the network layers.

Some examples of the present invention relate to an apparatus providing a solution to control the problem posed by low resistance of cells in comparison to resistance of connection lines, to achieve a reliable instant analog approximation of an output for a neural network layer of a size that is not, within the common neural network inference practice, limited by the ratio of the resistance of cells to the resistance of connection lines. There are naturally other practical limitations on the size of the layer due to the manufacturing technology, yet they are not that severe. The current MTJ manufacturing technology may, for instance, potentially allow production of memory cells crossbars of linear size up to 30,000, which would accommodate neural network layers of up to 30,000 neurons.

The particular and specific ways to achieve the solution are specified in the description below. The instant character of the approximation is ensured by the analog nature of the computation (the immediate propagation of the current), but the approximation's reliability requires a sufficient degree of correspondence of the resulting current distribution to the values expected for the exact network inference. The reliability is measured by the resulting network prediction accuracy (the percentage of cases when the prediction is correct). The goal of the invention is to overcome the limitation that arises from the low resistance of cells in comparison to the resistance of connection lines and which is specifically posed by the conventional construction of the analog solution apparatus as a resistive crossbar array with cross-point connections that involve straight single wire input and output connection lines.

Computer modeling results show that with the conventional construction of a crossbar, the results of the analog approximation start to significantly deviate (as to statistically significantly degrade the neural network's measured prediction accuracy) from the values expected for the exact network inference, once the ratio of resistance of cells to the resistance of lines, connecting the neighboring cells, is below the square of the size of the neural network layer (that is, the number of neurons in the layer). For instance, the maximal fall of the output neuron signal, relative to the expected exact neuron output signal, reaches 10% at a ratio of 10 times the square of the size of the layer, and reaches 92% (which is approximately 1−(1−0.1)²⁵) once the size of the layer grows 10 times beyond that. A graph with plots of dependence of the maximal fall value of the output neuron signal relative to the expected exact neuron output signal, depending on the ratio of resistance of cells to resistance of connection lines, and on the size of the layer modeled, is shown in FIG. 1. This distortion of the output signal, due to the low resistance of cells in comparison to the resistance of connection lines, growing with the number of neurons, limits the size of the networks (their number of neurons), available for analog inference, thus severely limiting the network's prediction power. Conventional designs of MTJ memory cells and the crossbar allow reliable instant analog approximation of the output for neural network layers of about 50 neurons. The reasons for such limitations are due to Kirchhoff's circuit laws, and the solutions are offered in the present invention.

Some examples of the invention provide a solution by prevention of currents flow through the cells in a reverse direction. Such prevention is for instance achieved by attaching diodes to the memory cells. The prevention of reverse currents flow allows getting rid of a significant part of the influence of parasitic currents. Computer modeling results show that prevention of reverse currents flow could provide an increase of the size of the layer by up to 2.5 times relative to the limitation posed by the conventional construction of the crossbar, as described above. However, that solution alone is not sufficient to entirely neutralize the parasitic currents effects. Applying other examples of the present invention makes neutralization of parasitic currents even more efficient.

Some examples of the present invention provide an apparatus to achieve a reliable instant analog approximation of the output for the neural network layer of the size not practically limited by the ratio of resistance of cells to resistance of connection lines by means of configuration and/or topology of connection lines different from a conventional unbalanced (or insufficiently balanced) cross-point connection that involves straight single wire input and output connection lines (FIG. 2).

An example of the present invention's crossbar connection lines 40 scheme made as binary balanced tree of connecting lines is shown in FIG. 3. The overall 3D structure of the crossbar 20 with the connection lines 40, made as binary balanced trees, would look as illustrated by FIG. 12. A partially balanced (non-binary) tree involving also conventional straight single wire connecting lines at individual levels, allows to decrease the number of branching levels while preserving sufficient balance when the square of the length of an individual single wire connecting line does not exceed the ratio of resistance of cells to the resistance of connection lines. Although a uniform voltage drop will occur, that will not degrade the accuracy as long as dynamic noise source is controlled, which is well achievable by conventional means.

Computer modeling results show that connection lines 40 made with the scheme of a binary balanced tree could provide an increase of the size of the layer by up to 10 times relative to the limitation posed by the conventional construction of the crossbar.

Some examples of the present invention provide an apparatus for the reliable instant analog approximation of the output for the neural network layer of the size not practically limited by the ratio of resistance of cells to resistance of connection lines by means of specific properties of memory cells such as high resistance, reduced energy barrier for fast and low power readout, use of quantum materials with an enhanced charge to spin conversion ratio (high spin Hall angle), and in particular use of topological insulators and/or materials with the giant Rashba spin splitting effect, for increasing the writing speed, and/or for decreasing the writing time, and/or for enabling a larger cell size, acceptance of a higher percentage of cells not usable for memory storage, higher percentage of read errors, short memory retention time, and/or combination thereof. The particular ways for specific memory cell properties listed above to achieve and to provide the layer size increase are described below.

The type of the non-volatile memory that allows to achieve both high resistance of the cells, fast operational time and low power consumption, necessary for edge devices, is the cells using the MTJ (Magnetic Tunnel Barrier) technology.

The most promising MTJ memory cell type allowing the cells' high resistance level is of cells based on SOT (Spin-Orbit Torque) technology. The resistance levels of SOT MTJ cells may reach 1 MΩ or more, while for other types of MTJ memory cells, the resistance normally does not exceed 10 KΩ. The main device to increase the resistance level of the SOT cell is thickening of the tunneling barrier, which is made possible by the fact that the SOT mechanism for memory write is not passing the current through the tunneling barrier (FIG. 4), therefore not requiring high voltages to perform the SOT memory write even when the resistance of the barrier is very high. Specific ways in which SOT MTJ cells may be adopted to the requirements of reliable instant analog neural networks approximation are described below.

Computer modeling results show that the higher resistance of SOT MTJ cells, to the levels noted above, could provide an increase in the size of the layer up to 30 times relative to the limitation posed by the conventional construction of the crossbar.

A reduction of the energy barrier (FIG. 5) between the parallel and antiparallel states of the MTJ memory cells allows faster and, most importantly, lower power readout of the cell's state. Among the ways to achieve the reduction of the energy barrier, covered in the present invention, are: a thinner free layer of the cell (FIG. 6) and the overall cell's shape optimization for that objective, by means of physical (theoretical and experimental) and computer modeling. The mechanism of the shape optimization is the inner balance between conflicting parameters inherent to the design of the MTJ cell. The three most crucial parameters in conflict are: the percentage of read errors, the percentage of memory write errors, and the height of the energy barrier, which controls the memory retention time. The easier it is to reliably read the cell, the harder is to write it without the excessive voltage damaging the cell, and the lower the energy barrier, the easier it is to write but harder to retain the information. The balance of these parameters is controlled by the geometry and the shape of the cell's body design and manufacturing. In particular, the reduction of the energy barrier makes it easier to reach the required values of the other conflicting parameters within the given geometrical cell design limits.

Another example of how the cell design adopted for the instant analog approximation of the output for the neural network layer (as opposed to the reading of an individual state of the memory cell) helps to achieve fast operational time and low power consumption. For the cell design relating to neural network layer analog approximation, as opposed to the individual cell reading, there is no need to have an additional read line transistor (FIG. 4) or diode, and the simplification allows for the cell area reduction and for the read energy budget reduction.

The specific properties of memory cells listed above may be achieved with the use of quantum materials with an enhanced charge to spin conversion ratio (high spin Hall angle), and in particular use of topological insulators and/or materials with the giant Rashba spin splitting effect for cell implementation. For the SOT memory cell that may include in particular the use of topological insulators where conversion is enabled by the quantum spin Hall effect with a high (up to 52 deg) SH (spin Hall) angle, such as Bi0.9Sb0.1 (FIG. 7), for spin-orbit line, to increase the SOT memory write effectiveness, which also allows an increase in the cell size to achieve the low power readout and to boost the cell's manufacturing stability.

The trade-off between different properties of the cell could be improved in favor of instant analog approximation quality by allowing the non-volatile memory cells of kinds not appropriate for use as digital memory storage. The mechanism of the trade-off shift is the inner balance between conflicting parameters inherent to the design of the MTJ cell. The three most crucial parameters in conflict, as mentioned above, are: the percentage of read errors, the percentage of memory write errors, and the height of the energy barrier, which controls the memory retention time. The easier it is to reliably read the cell, the harder is to write it without the excessive voltage damaging the cell, and the lower the energy barrier, the easier it is to write but harder to retain the information. The cells violating certain conditions necessary for digital storage would instead satisfy the conditions required for efficient analog reading (the low read energy and high resistance). Among these kinds of cells are: the cells with the size larger than required for the state-of-the-art digital memory storage (that is, a size of 45 nm or larger), the cells with a high percentage of non-functional cells (up to 5% of non-functional cells could be tolerated in instant analog approximation case, while for digital memory storage needs, even 0.1% is not tolerable), the cells with high probability of read errors (up to 1% of read errors could be tolerated in instant analog approximation case, while for digital memory storage needs, the read error tolerance rate that is below 10-8), the cells with the memory retention time that is short relative to the memory retention time required for the state-of-the-art digital memory storage (the digital memory energy barrier must provide the retention time of at least 10 years, while the energy barrier for the analog approximation cells could be lowered as to provide the memory retention time as low as 24 hours or even less, depending on the relevant edge device requirements).

Some examples of the present invention provide an apparatus, wherein parts of the ensemble of non-volatile memory cells are used alternatively as a digital memory/logic device or to perform a reliable instant analog approximation of a neural network layer output, including the solution where the cells usage is controlled by the preprogramming (or in particular, the run time reprogramming) for the ensemble of the cells or for some part of that ensemble.

Some examples of the present invention relate to the ways the apparatus may represent and use the separate bits of the multi-bit binary representation for the values of the neural network's weights to provide the required network inference accuracy. Computer modeling results show that 6 bits are sufficient for the tested tasks of MNIST, SVHN, CIFAR10 (FIGS. 8 to 10).

Two distinct specific ways of using separate bits of the neural network's weights for analog inference are presented as part of the present invention. The first is the separate production of output current distributions for every given bit index, on the matrix that collects the bits of that given index, for all the weight values, and then collecting these outputs together using an additional circuit. In that process, all memory cells, even those representing different bits of a multi-bit representation, could use the same scale of input voltage signals, as the output current distributions for every given bit index are produced separately. The second way is where output current distributions are produced for all bits of a multi-bit representation together, using different input voltage scales (approximately proportional to 2^{k} (2 to the power of k), where k is the given bit index, least significant to most significant) on memory cells representing different bits of a multi-bit representation. In that process, output current distributions representing all bit indexes are already collected together during the production. The way different input voltage scales are applied to memory cells representing different bits of a 6-bit representation of the NN weights, is illustrated by FIG. 11.

Some examples of the present invention present the involvement of the apparatus of a digital core that does not need to be constantly powered up in order to perform the required function. The non-volatile memory cells are only powered by the external signal input, and the wake-up controller only powers up the digital core and/or the plurality of control cells and/or devices in the case of a wake-up event. The detection of the wake-up event (which implies the presence of data signal coming to the input lines, but is not implied by the data signal) is the function performed by non-volatile memory cells, without the digital core involvement. The memory cells stay in “always-on” standby mode, not consuming the energy if no data signal is present, while the instant startup of the digital core is made possible by all the necessary start-up data already present by the non-volatile function of memory cells in the case of a wake-up event.

Some examples of the present invention provide methods to determine conditions and/or available solutions related to the task of reliable inference implementation on a given instance of the apparatus (given device) for a given pre-trained neural network. In particular, there are methods to determine the set of neural networks appropriate for inference on a given device as well as the set of device parameters appropriate for inference for a given neural network. A method is also presented that provides a concrete and specific reliable implementation on a given instance of the device for a given pre-trained neural network, if such implementation is in fact possible. The methods include applying a sequence of actions to obtain the required conditions and/or solutions while performing the computer modeling of the appropriate use of the apparatus described above, for a given concrete specific instance of the device (and/or set of similar devices) and the given pre-trained neural network.

The provided set of methods includes a method for an optimal binary representation of the pre-trained neural network weights. The idea of the method is that the levels of binary representation and/or the particular assignment of specific bits to the specific cells of a given device, and/or particular allocation of input and/or output channels, could be adjusted to better fit the particular properties of the particular instance of the device and the given neural network. The set of device properties mentioned above also includes the individual electrical properties of the device that are affected by its manufacturing process and are less than fully stable from a device to a device (but are stable for any particular device instance once the device is manufactured and produced). The specific actions involved may include a randomized Monte-Carlo type search for the optimal assignment of specific bits to the specific cells and/or for the optimal allocation of input and/or output channels for a given particular device instance and a given neural network layer.

### BRIEF DESCRIPTION OF THE DRAWINGS

FIG. 1 is a graph of the maximal value of the output neuron signal relative to the expected exact neuron output signal (vertical axis), depending on the ratio r/R (different curve colors) of resistance of cells to resistance of connection lines, and on the size (horizontal axis) of the neuron layer modeled.

FIG. 2 is a diagram of a conventional crossbar array connection scheme.

FIG. 3 is a diagram of the present balanced analog crossbar array connection scheme.

FIG. 4 is a diagram of the SOT memory write mechanism not passing the current (as opposed to STT write mechanism) through the tunneling barrier.

FIG. 5 is a diagram of the energy barrier between the parallel and antiparallel states of the MTJ memory cell.

FIG. 6 is an illustration of the free layer position of the MTJ memory cell with respect to the bit line layer.

FIG. 7 is an illustration of spin Hall angle values for different topological insulator materials.

FIG. 8 is a graph of the inference accuracy in % (vertical axis) for the MNIST task depending on the number of bits (different curve colors), and on the size (horizontal axis) of the neuron layer modeled.

FIG. 9 is a graph of the inference accuracy in % (vertical axis) for the SVHN task depending on the number of bits (different curve colors), and on the size (horizontal axis) of the neuron layer modeled.

FIG. 10 is a graph of the inference accuracy in % (vertical axis) for the CIFAR10 task depending on the number of bits (different curve colors), and on the size (horizontal axis) of the neuron layer modeled.

FIG. 11 is an illustration of how different input voltage scales are applied to memory cells representing different bits of a 6-bit representation of the NN weights.

FIG. 12 is an illustration of the overall 3D structure of the present crossbar with the connection lines made as binary balanced trees.

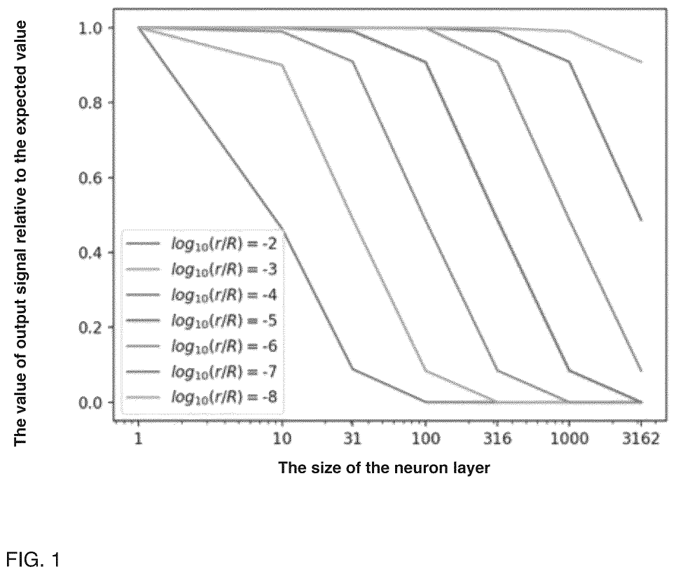

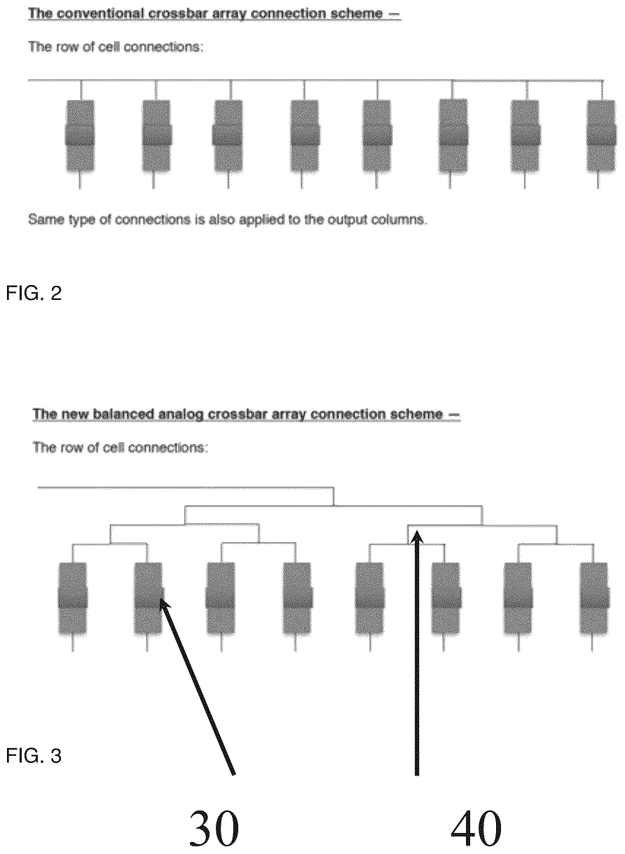

### DETAILED DESCRIPTION

The apparatus disclosed may be implemented in different variants. The apparatus may comprise interrelated components necessary to perform a reliable instant analog approximation of an inference output (the approximation for a reliable neural network inference) for a neural network layer (represented by a plurality of memory cells 30 organized into a crossbar 20) of the size not, within the common neural network inference practice, limited (as opposed to prior art solutions) by the ratio of the resistance of cells to the resistance of connection lines-namely, a plurality of non-volatile memory cells 30 of variable resistance organized to perform the required instant analog approximation (for example by current distribution governed by the conductivity of the circuit elements, that is of memory cells 30 and connection lines 40), a plurality of control cells and/or devices, and a plurality of connection lines necessary to organize an ensemble of the non-volatile memory cells of variable resistance. Specific methods and devices allowing these components to ensure the reliable instant analog approximation of the output for the neural network layer of the size not practically limited (as opposed to prior art solutions) by the ratio of resistance of cells to resistance of connection lines are described below.

In some examples, the apparatus may perform the reliable instant analog approximation of the output for the neural network layer (represented by a plurality of memory cells 30 organized into a crossbar 20) of the size not practically limited by the ratio of resistance of cells to resistance of connection lines that is secured by prevention of currents flow through the cells in a reverse direction. Computer simulation shows such prevention to limit the influence of parasitic currents that disrupt the accuracy of analog approximation of the output for the neural network layer with a crossbar 20 of a large size. Such prevention of reverse currents could, for example, be made with the controlling diodes attached to the memory cells 30 input connection lines 40.

It is also possible to achieve reliable instant analog approximation of the output for the neural network layer (represented by a crossbar 20) of the size not practically limited by the ratio of resistance of cells to resistance of connection lines with a configuration and/or topology of connection lines 40 different from a conventional cross-point connection that involves straight single wire input and output connection lines. This ensures a well-balanced output current distribution relative to the one achieved with prior art solutions. The reason for the better balance of output current distribution is that the geometry and the topology of input and output connections leading to any specific memory cell do not depend (or in a lesser degree depend) on the position of the cell in the array.

The configuration of input and/or output connection lines 40 may involve a multi-level tree structure of connections of input/output line to an array of cells allowing an evenly balanced distribution of input/output currents over the connected memory cells 30. Moreover a multi-level tree structure of connections may either be a binary balanced tree of connecting lines or a non-binary tree of connecting lines involving also conventional straight single wire connecting lines at individual levels.

It is also possible for the apparatus to achieve a reliable instant analog approximation of the output for the neural network layer (represented by a crossbar 20) of the size not practically limited by the ratio of resistance of cells to resistance of connection lines which is ensured by specific properties of memory cells 30 such as high resistance, reduced energy barrier for fast and low power readout, use of quantum materials with an enhanced charge to spin conversion ratio (high spin Hall angle), and in particular use of topological insulators and/or materials with the giant Rashba spin splitting effect, for increasing the writing speed, and/or for decreasing the writing time, and/or for enabling a larger cell size, acceptance of a higher percentage of cells not usable for memory storage, higher percentage of read errors, short memory retention time, and/or combination thereof. The ways in which these specific methods and devices allow the required quality of analog approximation are described below.

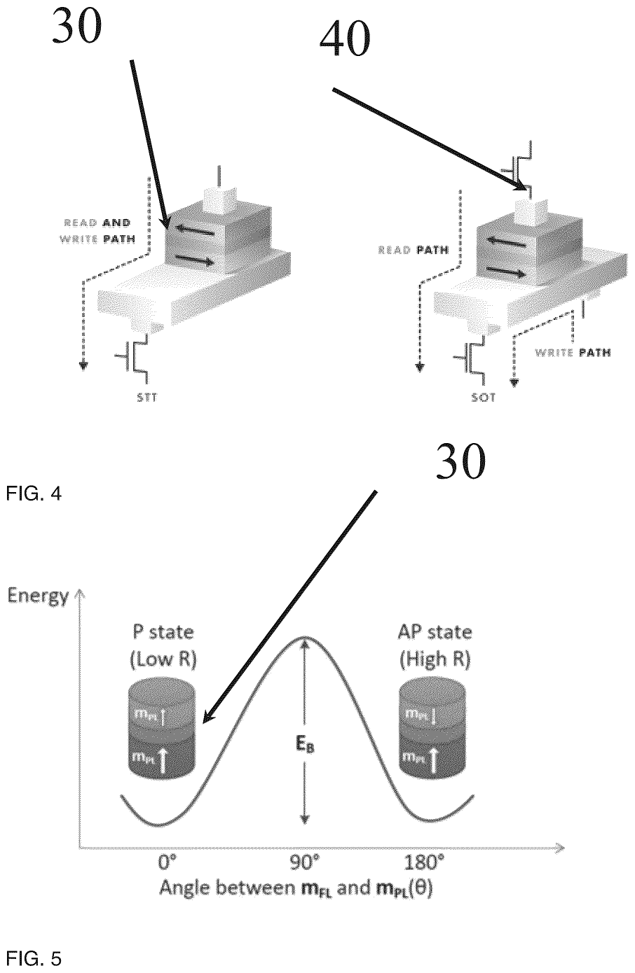

It is possible for the apparatus to achieve a reliable instant analog approximation of the output for the neural network layer (represented by a crossbar 20) of the size not practically limited by the ratio of resistance of memory cells 30 to resistance of connection lines 40 which is ensured by means of sufficiently high resistance of the memory cells 30. The sufficiently high resistance of the memory cells 30 ensures the sufficiently high ratio of the resistance of the cells to resistance of the connection lines, which in turn removes the main obstacle limiting the size of the neural network layer (represented by a crossbar 20, the size of which corresponds to the size of the layer) that is suitable for the reliable instant analog approximation. Moreover, the memory cells 30 could be implemented using MTJ (Magnetic Tunnel Barrier) technology. The high resistance of the memory cell might be provided by applying SOT (Spin-Orbit Torque) memory cell technology. The resistance levels of SOT MTJ cells may reach 1 MΩ or more, while for other types of MTJ memory cells, the resistance normally does not exceed 10 KΩ. The main device to increase the resistance level of the SOT cell is thickening of the tunneling barrier, which is made possible by the fact that the SOT mechanism for memory write is not passing the current through the tunneling barrier (FIG. 4), therefore not requiring high voltages to perform the SOT memory write even when the resistance of the barrier is very high. As noted above, computer modeling results show that higher, to the levels just described, resistance of SOT MTJ cells provides an increase in the size of the layer up to 30 times relative to the limitation posed by the conventional construction of a crossbar 20.

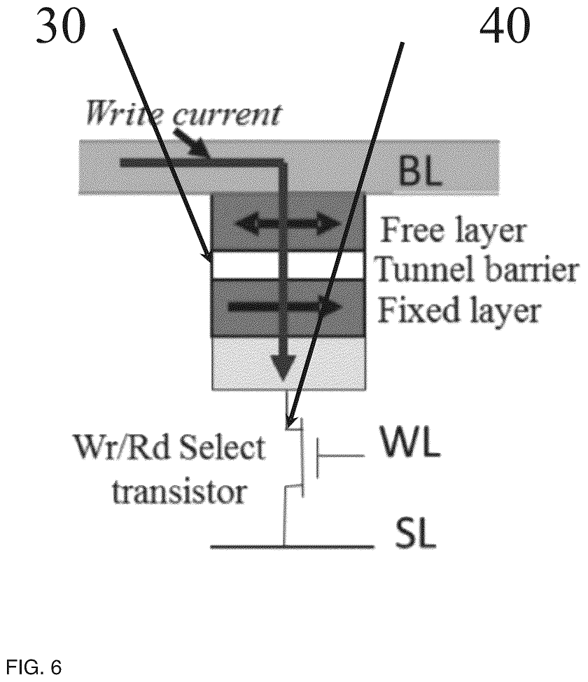

The property of the high resistance of the SOT memory cell may be satisfied with a reduced energy barrier for fast and low power readout. The reduction of the energy barrier could be achieved by a thinner free layer of the cell (FIG. 6) or by optimization of the cell's shape. The mechanism of shape optimization is the inner balance between conflicting parameters inherent to the design of the MTJ cell: the percentage of read errors, the percentage of memory write errors, and the height of the energy barrier, which controls the memory retention time. The balance of these parameters is controlled by the geometry and the shape of the cell's body design and manufacturing. In particular, the reduction of the energy barrier, while decreasing the memory retention time, makes it easier to reach the required values of the other conflicting parameters within the given geometrical cell design limits.

The construction of the SOT cell for the purpose of instant analog approximation (as opposed to for RAM construction) does not require the read-line transistor or diode (as opposed to prior art solutions with non-SOT cells), thus allowing for both cell area and energy reduction. This is by itself a distinctive property of using the SOT cells for the instant analog approximation.

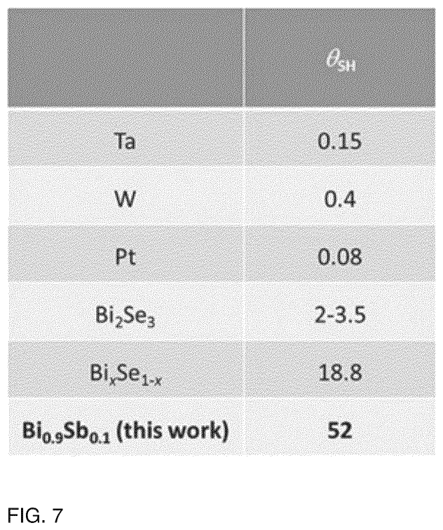

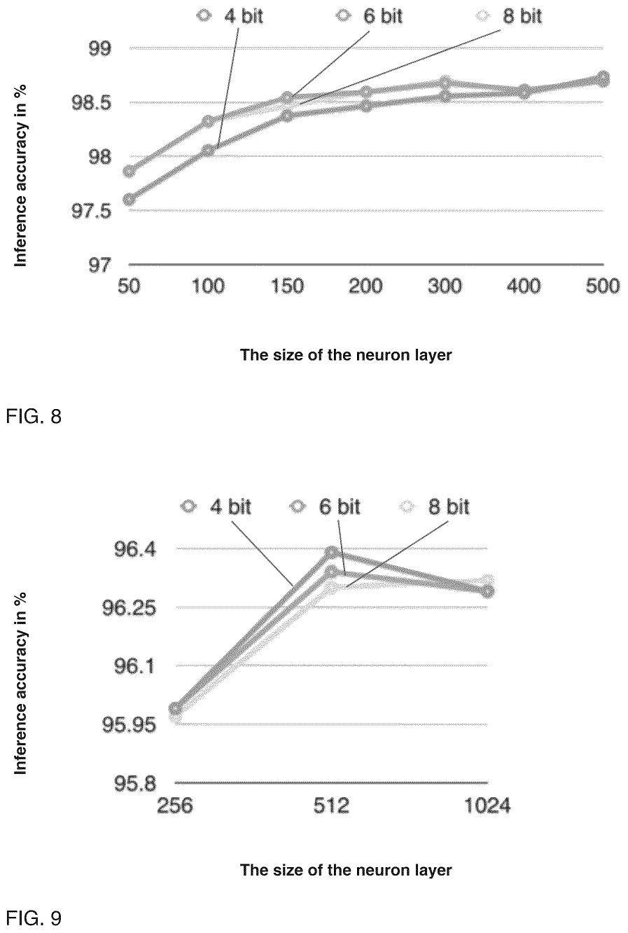

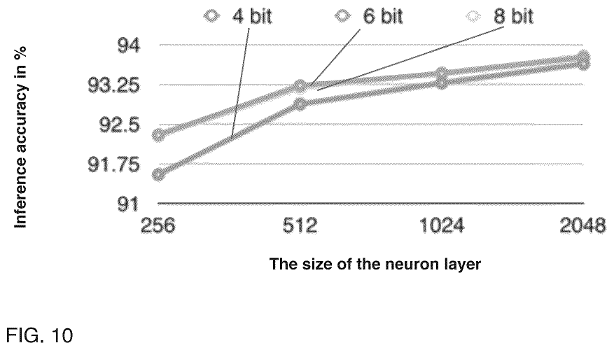

The desired specific properties of the memory cells 30 could be ensured with use of quantum materials with the enhanced charge to spin conversion ratio (high spin Hall angle), and in particular use of topological insulators and/or materials with the giant Rashba spin splitting effect for cell implementation. In particular, these properties could be ensured by applying the SOT (Spin-Orbit Torque) memory cell construction with use of quantum materials with an enhanced charge to spin conversion ratio (high spin Hall angle), and in particular use of topological insulators and/or materials with the giant Rashba spin splitting effect for spin-orbit line. The use of quantum materials with an enhanced charge to spin conversion ratio may include the use of topological insulators with a SH (spin Hall) angle up to 52 degrees, such as Bi0.9Sb0.1 (FIG. 7), to increase the SOT memory write effectiveness, which will also allow increasing the cell size to achieve the low power readout and to boost the cell's manufacturing stability.

The specific properties of the memory cells 30 may involve properties that were not appropriate for use of the memory cells as digital memory storage. In some examples, this involves using a cell size larger than that required for the state-of-the-art digital memory storage (45 nm or larger), to ensure the low power readout. In other examples, this involves the use of a significant percentage of cells not usable for memory storage, while the ensemble of the cells is still usable to perform the reliable instant analog approximation of the neural network layer output. Computer simulation shows cases when up to 5% of non-functional cells could be tolerated. In yet other examples, this involves the use of cells with a significant percentage of read errors, while the ensemble of the cells is still usable to perform the reliable instant analog approximation of the neural network layer output. Computer simulation shows cases when up to 1% of read errors could be tolerated. In still another example, this involves the use of a relatively short memory retention time, while the ensemble of the cells is still usable to perform the reliable instant analog approximation of the neural network layer output within the specified retention time frame. For certain applications, the energy barrier for the analog approximation cells could be lowered to provide a memory retention time as low as 24 hours or even less, depending on the relevant device requirements.

The parts of the plurality of the non-volatile memory cells 30 of the apparatus could be used alternatively as a digital memory/logic device or as to perform reliable instant analog approximation of the neural network layer output. The alternative use of the same part of the ensemble of cells as either digital memory/logic device or to perform the reliable instant analog approximation of the neural network layer output could be controlled by the preprogramming or by the run time reprogramming for the ensemble of the cells or for some part of that ensemble. The control mentioned, the preprogramming, or the run time reprogramming could be performed either by direct programming of the in-memory logic with the non-volatile memory cells 30 or by the auxiliary control cells and/or devices, including the digital ones.

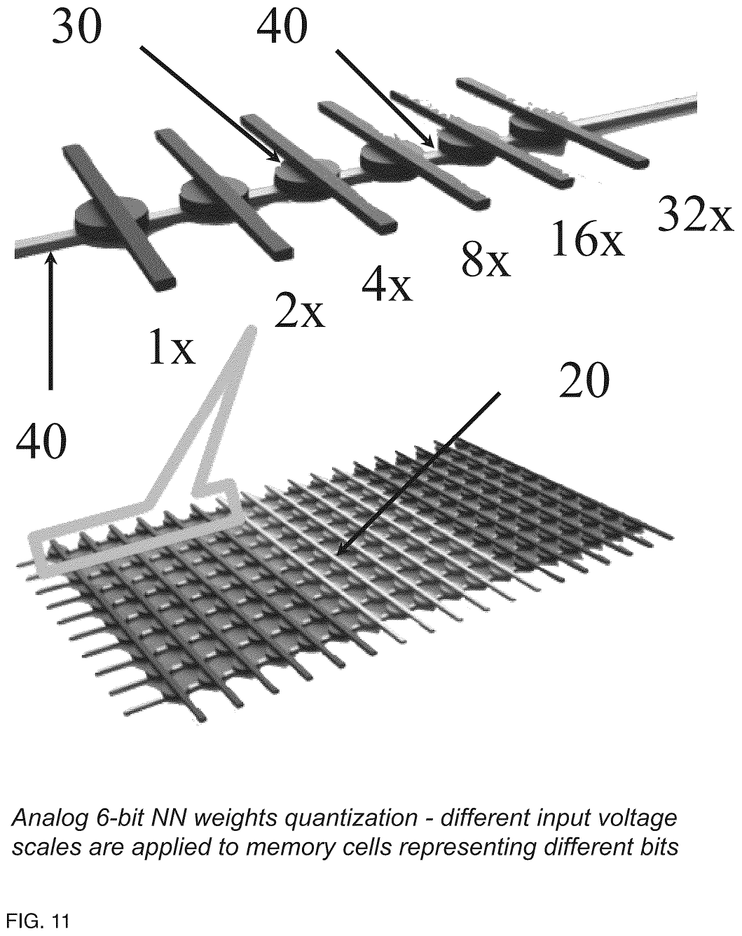

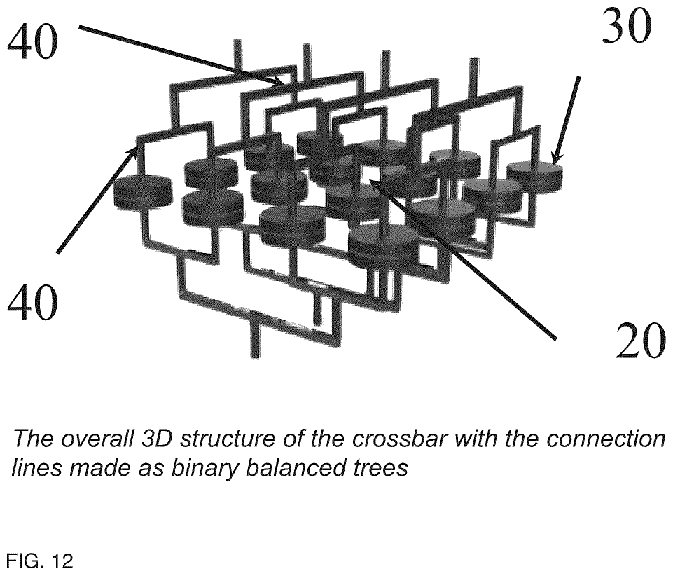

The separate memory cells of the plurality of non-volatile memory cells 30 of the apparatus could be used to represent separate bits for the multi-bit binary representation for the values of the neural network weights. The resulting output current distributions for the memory cells 30 of the apparatus that represent separate bits for the multi-bit binary representation for the values of the neural network weights, may be produced for each bit of a multi-bit representation separately and then collected together using an additional circuit-in which case all memory cells 30, even those representing different bits of a multi-bit representation, could use the same scale of input voltage signals, as the output current distributions for every given bit index are produced separately, or they may be produced for all bits of a multi-bit representation together using different input voltage scales on the memory cells 30 representing different bits of a multi-bit representation-in which case the scales would be approximately proportional to 2^{k} (2 to the power of k), where k is the given bit index, least significant to most significant. The way different input voltage scales are applied to the memory cells 30 representing different bits of a 6-bit representation of the NN weights, is illustrated by FIG. 11.

The plurality of control cells and/or devices of the apparatus may involve a digital processor core and the plurality of the memory cells 30 that are connected to data input lines from the data source and to the control lines of the aforementioned digital processor core.

In the apparatus, the digital processor core and/or the plurality of control cells and/or devices could be set up to be powered up by a wake-up controller, connected to the plurality of the memory cells 30 and the digital processor core, in case of a wake-up event only. The plurality of memory cells 30 may also stay permanently in “always-on” standby mode, not consuming the energy, while in the event of a data signal coming to the input lines, the signal is initially processed by the plurality of memory cells 30 that perform the initial analog neural network approximation procedure to determine the need for the digital processor core and/or the plurality of control cells and/or devices to wake up. The detection of the wake-up event (which implies the presence of a data signal coming to the input lines, but is not implied by the data signal) could then be the function performed by non-volatile memory cells 30, without the digital core involvement.

In some examples of the invention there are provided methods to determine conditions and/or available solutions related to the task of reliable inference implementation on a given device instance of the apparatus (given device) for a given pre-trained neural network. In particular, there are methods to set up the approximate neural network inference performing the computer modeling for the use of the apparatus described above, modeling a sequence of actions to determine if an inference for a given pre-trained neural network could be reliably implemented on a given device instance of any example of the apparatus described above; to determine the required properties of a device instance of any example of the apparatus described above that could be used to reliably implement an inference for a given pre-trained neural network; to determine the required characteristics of a given pre-trained neural network so that its inference could be reliably implemented on a given device instance of the same example of the apparatus mentioned above; and to provide a reliable implementation on a given device instance of the same example of the apparatus mentioned above for a given pre-trained neural network that could be reliably implemented on that device instance.

In the methods and apparatus noted above, a reliable implementation of an inference for a given pre-trained neural network may use separate memory cells of the plurality of non-volatile memory cells 30 to represent separate bits for the multi-bit binary representation for the values of the neural network weights. In that instance, a separate memory cells representation of separate bits for the multi-bit binary representation for the values of the neural network weights may be adjusted to optimally, or nearly optimally fit the specific particular instance of specifications, configuration and/or topology of the cells and/or connection lines of a specific particular instance of a device described above. The above representation of separate bits for the multi-bit binary representation for the values of the neural network weights may also be adjusted to optimally, or nearly optimally fit the specific particular instance of manufactured properties of the cells and/or connection lines of a specific particular instance of a manufactured device described above. The idea of the method is that the levels of binary representation and/or the particular assignment of specific bits to the specific cells of a given device and/or particular allocation of input and/or output channels could be adjusted to better fit the particular properties of the particular instance of the device and the given neural network. That includes also the individual electrical properties of the device that are affected by its manufacturing process and are less than fully stable from a device to a device (but are stable for any particular device instance once the device is manufactured). The specific actions involved may include a randomized Monte-Carlo type search for the optimal assignment of specific bits to the specific cells and/or for the optimal allocation of input and/or output channels for a particular device instance and a given neural network layer.

1. An apparatus for an approximate neural network inference, the apparatus comprising: a plurality of non-volatile memory cells of variable resistance organized to perform an instant analog approximation for a neural network inference, including the inference for neural network layers; and other circuit elements including connection lines, the circuit elements being configured to control a current distribution, which is governed by the conductivity of the circuit elements, for the instant analog approximation of the inference output wherein the neural network layers have a size beyond state-of-the-art limits dictated by a ratio of resistance of memory cells to resistance of the connection lines.

2. The apparatus of claim 1, wherein the plurality of the non-volatile memory cells of variable resistance is configured by a plurality of control cells and/or devices provided to perform the instant analog approximation of the inference output for the neural network layer of the size beyond limits dictated by the ratio of resistance of cells to resistance of connection lines.

3. The apparatus of claim 1, wherein the plurality of the non-volatile memory cells of variable resistance is configured by a plurality of connection lines provided to ensure the reliability of the instant analog approximation of the inference output for the neural network layer of the size beyond limits dictated by the ratio of resistance of cells to resistance of connection lines.

4. The apparatus of claim 1, wherein the instant analog approximation of the output for the neural network layer of the size beyond limits dictated by the ratio of resistance of cells to resistance of connection lines is secured by prevention of currents flow through the cells in a reverse direction.

5. The apparatus of claim 3, wherein the instant analog approximation of the output for the neural network layer of the size beyond limits dictated by the ratio of resistance of cells to resistance of connection lines is ensured by a configuration and/or topology of connection lines distinct from a conventional cross-point connection that involves straight single wire input and output connection lines.

6. The apparatus of claim 5, wherein the configuration of input and/or output connection lines involves a multi-level tree structure of connections of input/output line to an array of cells.

7. The apparatus of claim 6, wherein the multi-level tree structure of connections is a binary balanced tree of connecting lines.

8. The apparatus of claim 6, wherein the multi-level tree structure of connections is a non-binary tree of connecting lines involving also conventional straight single wire connecting lines at individual levels.

9. The apparatus of claim 1, wherein the instant analog approximation of the output for the neural network layer of the size beyond limits dictated by the ratio of resistance of cells to resistance of connection lines is ensured by specific properties of memory cells such as high resistance, reduced energy barrier for fast and low power readout, use of quantum materials with an enhanced charge to spin conversion ratio (high spin Hall angle), and in particular use of topological insulators and/or materials with the giant Rashba spin splitting effect, a large cell size, acceptance of a higher percentage of cells not usable for memory storage, higher percentage of read errors, short memory retention time, and/or combination thereof.

10. The apparatus of claim 9, wherein the instant analog approximation of the output for the neural network layer of the size beyond limits dictated by the ratio of resistance of cells to resistance of connection lines is ensured by means of sufficiently high resistance of the memory cells.

11. The apparatus of claim 10, wherein the memory cells are implemented using Magnetic Tunnel Barrier technology.

12. The apparatus of claim 10, wherein the property of the high resistance of the memory cell is satisfied by applying a Spin-Orbit Torque memory cell construction, involving a memory write mechanism not passing the current through the tunneling barrier.

13. The apparatus of claim 12, wherein the property of the high resistance of the Spin-Orbit Torque memory cell is satisfied by thicker tunneling barrier, than what is possible for other MTJ based memory cell types.

14. The apparatus of claim 12, wherein the property of the high resistance of the Spin-Orbit Torque memory cell is satisfied with a reduced energy barrier, relative to the levels appropriate for the RAM memory, for fast and low power readout.

15. The apparatus of claim 14, wherein the property of reduced energy barrier is satisfied by a thinner free layer than what is appropriate for the RAM memory.

16. The apparatus of claim 14, wherein the property of reduced energy barrier is satisfied by optimization of the cell's shape.

17. The apparatus of claim 12, wherein the construction of the Spin-Orbit Torque cell does not involve the read line transistor of diode, thus allowing for the cell area and energy reduction.

18-25. (canceled)

26. The apparatus of claim 2, wherein parts of the plurality of non-volatile memory cells are used alternatively as digital memory/logic device or as to perform the instant analog approximation of the neural network layer output.

27. (canceled)

28. The apparatus of claim 1, wherein separate memory cells of the plurality of nonvolatile memory cells are used to represent separate bits of the multi-bit binary representation for the values of the neural network weights.

29. (canceled)

30. The apparatus of claim 28, wherein the output current distributions for memory cells representing separate bits of the multi-bit values for the neural network weights are produced for each bit of a multi-bit representation separately and then collected together using an additional circuit.

31. The apparatus of claim 28, wherein the output current distributions for memory cells representing separate bits of the multi-bit values for the neural network weights are produced for all bits of a multi-bit representation together using different input voltage scales on memory cells representing different bits of a multi-bit representation.

32-34. (canceled)

35. A method comprising: performing computer modeling for the use of the apparatus of claim 1; and applying an appropriate sequence of actions to determine conditions and/or available solutions related to the task of inference implementation on a given device instance of that apparatus for a given pre-trained neural network.

36. The method of claim 35, further comprising applying a sequence of actions to determine if the inference implementation for a given pre-trained neural network could be implemented on a given device instance of the apparatus.

37. The method of claim 35, further comprising applying a sequence of actions to determine the required properties of a device instance of the apparatus that could be used to implement an inference for a given pre-trained neural network.

38. The method of claim 35, further comprising applying a sequence of actions to determine the required characteristics of a given pre-trained neural network so that inference of the network could be implemented on a given device instance of the apparatus.

39. The method of claim 35, further comprising applying a sequence of actions to provide an inference implementation on a given device instance of the apparatus for a given pre-trained neural network that could be implemented on that device instance.

40-42. (canceled)
